(19) United States
(12) Patent Application Publication
(10) Pub. No.: US 2026/0291665 A1
(43) Pub. Date: Sep. 24, 2026

(54) PLACEMENT OF NETWORK FUNCTIONS IN A NETWORK

(71) Applicant: Telefonaktiebolaget LM Ericsson (publ), Stockholm (SE)

(72) Inventors: Roghayeh JODA, Ottawa (CA); Sima NASERI, Ottawa (CA); Mona HASHEMI, Toronto (CA); Christopher RICHARDS, Ottawa (CA)

(21) Appl. No.: 19/473,617

(22) PCT Filed: Apr. 12, 2024
(86) PCT No.: PCT/IB2024/053620

§ 371 Date: Oct. 8, 2025

Related U.S. Application Data
(60) Provisional application No. 63/496,132, filed on Apr. 14, 2023.

(51) Int. Cl. H04L 5/00; H04L 41/16

(52) U.S. Cl. CPC H04L 5/0032; H04L 5/0005; H04L 41/16

(57) ABSTRACT

A method, system and apparatus are disclosed. A first network node (NN) configured to communicate with a with a plurality of NNs in a network is described. The first network node is configured to, and/or includes a communication interface and/or processing circuitry configured to determine a plurality of distributed unit network functions (DU NFs) to be hosted by a group of NNs of the plurality of NNs based on a delay target of each wireless device (WD) of a plurality of WDs, where each DU NF is associated with at least a component carrier usable by at least one WD, and the plurality of DU NFs is determined using a learning process. Further, each NN of the group of NN is triggered to host a corresponding DU NF of the plurality of DUs.

### TECHNICAL FIELD

The present disclosure relates to wireless communications, and in particular, to placement of network functions in a network where the network functions are associated with carrier aggregation.

### BACKGROUND

The Open Radio Access Network (O-RAN) alliance has developed and is developing O-RAN standards and/or specifications for wireless communication systems which may comprise O-RAN based mobile networks. Such systems provide, among other features, broadband communication between network nodes (NNs), such as base stations, and mobile wireless devices (WD) or user equipment (UE)), as well as communication between network nodes and between WDs. The terms WD and UE can be used interchangeably throughout the present disclosure.

Further, O-RAN includes technology which is based on disaggregation, virtualization, open interface, automation and intelligence. O-RAN provides flexibility, scalability, robustness, and cost efficiency but also generates unprecedented new revenue possibilities for the network operators and Communication Service Providers (CSPs).

Disaggregation in O-RAN makes the Network Functions (NFs) beyond the Radio Unit (RU) be distributed into Centralized Units (CUs) and Distributed Units (DUs) based on a specified network functional split, e.g., as shown in FIG. 1. Virtualization helps the CUS and DUs on the O-RAN Cloud (O-Cloud) nodes run efficiently by creating Virtualized Network Functions (VNFs) or Containerized Network Functions (CNFs).

Finding the best O-Cloud nodes to host the VNFs of each DU and CU while satisfying the delay demand of the UEs is currently being studied. For example, the latency aware DU-CU placement in the packet-based networks may be considered such as to formulate a problem as a Mixed Integer Linear Problem (MILP). A Deep Reinforcement Learning (DRL) algorithm for the problem of joint DU and CU placement and RU association may be used. Further, actor-critic learning algorithms may be used to minimize the energy consumption while satisfying the delay targets of the users.

In addition, Carrier Aggregation (CA) techniques have been introduced in LTE-advanced and used in 5G wireless mobile networks, in which Component Carriers (CCs) are aggregated to improve the throughput of the WDs. In CA, each WD is assigned to a Primary Cell (PCell) and this PCell always is active for that specific WD. However, the Secondary Cells (SCells) can be activated or deactivated during the time that WD is connected to the network. Each cell has its own Medium Access Control (MAC) and Radio Link Control (RLC) while Radio Resource Control (RRC) and other upper layers are the same for the different cells. Since SCells are dynamically activated or deactivated for different users, it is beneficial to leverage the disaggregation and virtualization aspects of cloud based RANs such as O-RAN to reduce the cost of network operators.

In current communication network technologies, the NEs of the DUs for each CC run in a fixed node. If the DU for all CCs runs in one processing node, this leads to a long delay from the DU to the WDs. The delay consists of propagation, processing, transmission, and scheduling/queuing. Further, optimizing the placement of CCs in DU NF instances, and DU NF instances in cloud nodes is an extremely complex and time intensive task.

### SUMMARY

Some embodiments advantageously provide methods, systems, and apparatuses for RAN network function placement with carrier aggregation in cloud network(s) using machine learning processes. In some embodiments, by exploiting the virtualization technique in a cloud network, the network nodes (e.g., optimum processing nodes) in the cloud network may be determined to run the network functions of DUs for different CCs.

In some other embodiments, a Deep Q-Network (DQN) based Deep Reinforcement Learning (DRL) scheme is used to minimize end-to-end delay (e.g., of the users) and the number of network nodes (e.g., O-Cloud nodes) used to place the DU NFs, while satisfying the delay target of users. That is, an ML solution for the problem of DU network function placement with carrier aggregation in O-RAN is described.

In some embodiments, a DRL model that minimizes the WD user plane traffic delay is used when using carrier aggregation in a RAN, while at the same time minimizing the number of placed DU NFs so that a target WD delay is satisfied. In some other embodiments, constraints include RAN NF (CU, DU and RU) compute resources and inter NF communication link bandwidth.

In some other embodiments, a method is described and may include one or more of the following steps:
Modeling a communication network (i.e., network).
Modeling an end-to-end (E2E) delay in the communication network. Parameters® can be obtained from real data collected in the network (e.g., E2E WD delay today).
Including (e.g., in the modeling) the processing, transmission, propagation, and queuing delay which is from CU to the WD throughout the Midhaul (MH), IDU (Inter DU) and FH (Fronthaul).
Defining the WD Centric DU network function Placement with Carrier Aggregation optimization problem.
Using a weighted sum of the delay and the number of used network nodes (e.g., cloud nodes) to host DU network functions for the CCs.
Applying Deep Reinforcement Learning-based DU Placement with CA (DUPCA) (e.g., to the modeling).
Using a DRL algorithm to minimize the number of placed DUs while satisfying the delay target for each user. This is done by choosing the proper DU placement for each CC.

Real world input data from NNs (e.g., RAN cloud nodes and NFs) and/or constraints such as to produce model generation and a solution to a placement problem such as an OAM system to configure the instantiation RAN NFs of CCs in a cloud network. The model can be dynamically re-generated periodically as input parameters and constraints change over time.

One or more embodiments minimize end to end delay from the CU to the end WD in a network (e.g., cloud network) while considering the number of NNs (e.g., cloud nodes) to be used to instantiate the DU NFs for the CCs. One or more embodiments enables (e.g., determine) an optimal number of DU NFs to be instantiated on NNs (e.g., O-Cloud nodes) while satisfying the end user quality of service expectations, such as E2E delay. This optimization also leads to significant cost savings for the network operator such as:
Automating the DU placement operations. This is traditionally a highly skilled and time intensive manual task.
Providing network energy savings by optimizing the DU placements.

According to one aspect, a method in a first network node (NN) configured to communicate with a plurality of NNs in a network is described. The method includes determining one or more distributed units (DUs) to be hosted by at least one NN of the plurality of NNs based at least on a delay target associated at least with each wireless device (WD) of a plurality of WDs. Each DU of the one or more DUs being associated with at least a component carrier (CC) usable by at least one WD of the plurality of WDs to communicate with one or more NNs of the plurality of NNs. The one or more DUs are determined using a learning process. The method also includes causing the at least one NN of the plurality of NNs to host a corresponding DU of the one or more DUs based on the determined one or more DUs.

In some embodiments, the method further includes performing modeling of the network to determine the one or more DUs.

In some other embodiments, the method further includes performing modeling of an end-to-end delay in the network based on data collected in the network, where the one or more DUs are determined based on the modeling of the end-to-end delay.

In some embodiments, determining the one or more DUs comprises determining a DU placement on the at least one NN based on carrier aggregation parameters.

In some other embodiments, determining the one or more DUs comprises determining a weighted sum of a delay associated with data corresponding to the plurality of WDs and a number of NNs used to host the one or more DUs. The weighted sum is determined for the at least component carrier (CC) of a plurality of CCs.

In some embodiments, determining the one or more DUs using the learning process comprises one or more of (A) modeling a state as a delay satisfaction of one or more users associated with the plurality of WDs; (B) determining an action associated with the learning process, where the action is a placement of the one or more DUs in the at least one NN for the at least one NN to host the one or more DUs, and the placement is for a corresponding CC; and (C) determining a reward associated with the learning process, the reward being the weighted sum of the delay and the number of NNs used to host the one or more DUs for the plurality of CCs.

In some other embodiments, the one or more DUs are further determined based on one or more constraints, where the one or more constraints are based on computing capacity of the plurality of NNs, a bandwidth capacity of one or more mid-haul links, one or more inter-DU links, and one or more fronthaul links, and the delay target.

In some embodiments, determining the one or more DUs using the learning process comprises applying deep reinforcement learning-based DU placement with carrier aggregation (DUPCA) to minimize a quantity of DUs that are to be hosted by the at least one NN while satisfying the delay target of each WD.

In some other embodiments, the method further includes one or more of (A) receiving a set of data corresponding to the plurality of WDs; (B) hosting at least one DU of the one or more DUs that corresponds to a first activated CC of the at least one CC; (C) one or both of transmitting and receiving signaling associated with a first subset of the set of data to communicate with at least with a WD via an access network node using the first activated CC; and (D) forwarding a second subset of data of the set of data to at least one other DU of the one or more DUs. The at least one other DU corresponds to a second activated CC of the at least one CC. The second activated CC and the first activated CC are different.

In some embodiments, the one or more DUs are one or more DU network functions.

According to another aspect, a first network node (NN) configured to communicate with a plurality of NNs in a network. The first network node is configured to determine one or more distributed units (DUs) to be hosted by at least one NN of the plurality of NNs based at least on a delay target associated at least with each wireless device (WD) of a plurality of WDs. Each DU of the one or more DUs is associated with at least a component carrier (CC) usable by at least one WD of the plurality of WDs to communicate with one or more NNs of the plurality of NNs. The one or more DUs are determined using a learning process. Th first NN is configured to cause the at least one NN of the plurality of NNs to host a corresponding DU of the one or more DUs based on the determined one or more DUs.

In some embodiments, the first NN is further configured to perform modeling of the network to determine the one or more DUs.

In some other embodiments, the first NN is further configured to perform modeling of an end-to-end delay in the network based on data collected in the network, where the one or more DUs are determined based on the modeling of the end-to-end delay.

In some embodiments, determining the one or more DUs comprises determining a DU placement on the at least one NN based on carrier aggregation parameters.

In some other embodiments, determining the one or more DUs comprises determining a weighted sum of a delay associated with data corresponding to the plurality of WDs and a number of NNs used to host the one or more DUs. The weighted sum is determined for the at least component carrier (CC) of a plurality of CCs.

In some embodiments, determining the one or more DUs using the learning process comprises one or more of: (A) modeling a state as a delay satisfaction of one or more users associated with the plurality of WDs; (B) determining an action associated with the learning process, where the action is a placement of the one or more DUs in the at least one NN for the at least one NN to host the one or more DUs, and the placement is for a corresponding CC; and (C) determining a reward associated with the learning process, the reward being the weighted sum of the delay and the number of NNs used to host the one or more DUs for the plurality of CCs.

In some other embodiments, the one or more DUs are further determined based on one or more constraints. The one or more constraints are based on computing capacity of the plurality of NNs, a bandwidth capacity of one or more mid-haul links, one or more inter-DU links, and one or more fronthaul links, and the delay target.

In some embodiments, determining the one or more DUs using the learning process comprises applying deep reinforcement learning-based DU placement with carrier aggregation (DUPCA) to minimize a quantity of DUs that are to be hosted by the at least one NN while satisfying the delay target of each WD.

In some other embodiments, the first network node is configured to one or more of: (A) receive a set of data corresponding to the plurality of WDs; (B) host at least one DU of the one or more DUs that corresponds to a first activated CC of the at least one CC; (C) one or both of transmit and receive signaling associated with a first subset of the set of data to communicate with at least with a WD via an access network node using the first activated CC; and (D) forward a second subset of data of the set of data to at least one other DU of the one or more DUs. The at least one other DU corresponds to a second activated CC of the at least one CC. The second activated CC and the first activated CC are different.

In some embodiments, the one or more DUs are one or more DU network functions.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an O-RAN system including a RU, a DU and a CU;

FIG. 2 is a schematic diagram of an exemplary network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a block diagram illustrating an example virtualization environment according to some embodiments of the present disclosure;

FIG. 9 is a flowchart of an exemplary process in a network node according to some embodiments of the present disclosure;

FIG. 10 is a flowchart of an exemplary process in a network node according to some embodiments of the present disclosure;

FIG. 11 shows an example network with CA including a CU, multiple DUs and/or RUs serving multiple WDs according to some embodiments of the present disclosure; and

FIG. 12 shows an example service management and orchestration (SMO) framework according to some embodiments of the present disclosure.

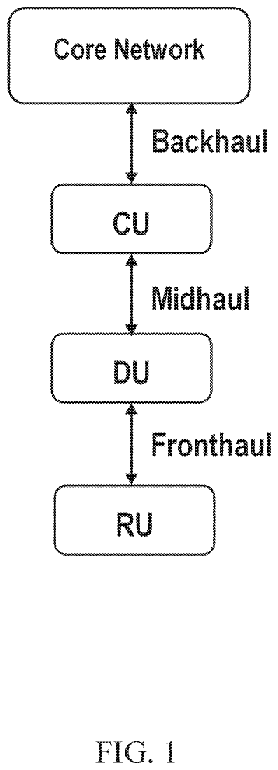

### DETAILED DESCRIPTION

Before describing in detail exemplary embodiments, it is noted that the embodiments reside primarily in combinations of apparatus components and processing steps related to network function placement with carrier aggregation in cloud network(s) using machine learning processes. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), a node such as a cloud node (e.g., O-Cloud node), a CU, a DU, an RU, etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

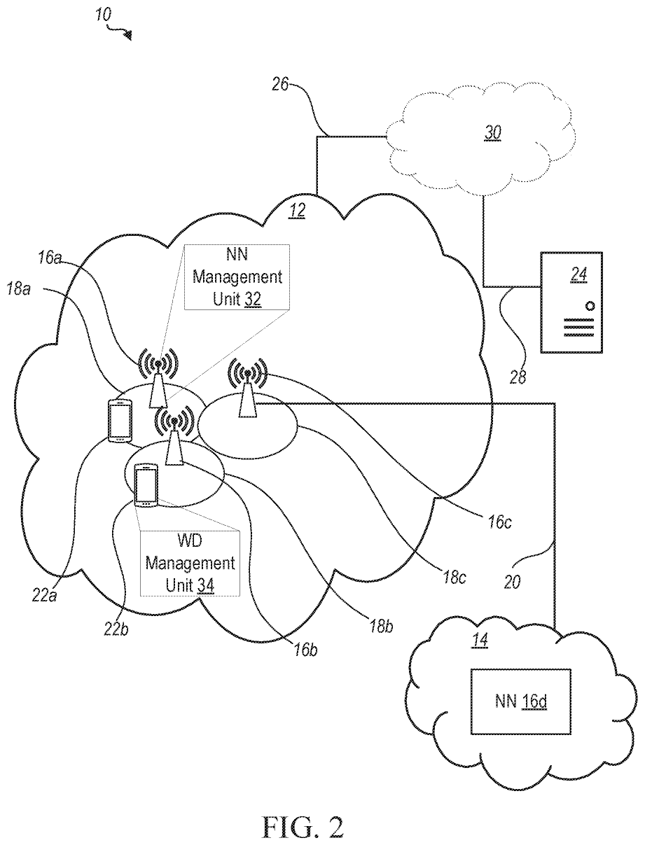

Referring now to the drawing figures, in which like elements are referred to by like reference numerals, there is shown in FIG. 2 a schematic diagram of a communication system 10, according to an embodiment, such as an O-RAN-type cellular network, which comprises an access network 12, such as a radio access network, and a core network 14. The access network 12 comprises a plurality of network nodes 16a, 16b, 16c (referred to collectively as network nodes 16), such as wireless access points, each defining a corresponding coverage area 18a, 18b, 18c (referred to collectively as coverage areas 18). A coverage area 18 may refer to a cell established by a network node 16. Thus, a cell may form a coverage area 18. As such, cell 18 is used interchangeably herein with coverage area 18. Each network node 16a, 16b, 16c is connectable to the core network 14 (and/or any other network nodes 14 such as network node 14d) over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Although communication system 10 has been referred to as an O-RAN-type cellular network, the present disclosure is not limited as such and may include any cellular network such as a Third Generation Partnership Project (3GPP) cellular network. The 3GPP has developed and is developing standards for Fourth Generation (4G) (also referred to as Long Term Evolution (LTE)) and Fifth Generation (5G) (also referred to as New Radio (NR)) wireless communication systems. The 3GPP is also developing standards for Sixth Generation (6G) wireless communication networks. That is, the communication system 10 may be a 3GPP-type cellular network that may support standards such as LTE and/or NR (5G) and/or 6G. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown). Any one of access network 12, core network 14, and intermediate network 30 may be at least in part a cloud network.

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., NN functions. A wireless device 22 is configured to include a WD management unit 34 which is configured to perform any step and/or task and/or process and/or method and/or feature described in the present disclosure, e.g., WD functions.

Example implementations, in accordance with an embodiment, of the WD 22, network node 16 and host computer 24 discussed in the preceding paragraphs will now be described with reference to FIG. 2. In a communication system 10, a bost computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to bost computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host management unit 54 configured to enable the service provider to observe/monitor/control/transmit to/receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. Software 74 may include one or more software applications such software applications associated with O-RAN and/or confirming with O-RAN specifications. In some embodiments, the software application may be at least one rApp. The term rApp may refer to a software application configured run on the Non-Real Time RAN Intelligent Controller (Non-RT RIC) (e.g., processing circuitry 68 and/or processor 70) to realize different functions such as RAN management and optimization. Software 74 may also include services configured to enable and/or provide and/or perform functions for software applications such as rApps. Software 74 may also include a framework such as a collection of reusable software components that may be usable to develop and execute software applications. An example of a framework is a Non-RT RIC framework.

The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN management unit 32 which is configured to perform any step and/or task and/or process and/or method and/or feature described in the present disclosure, e.g., NN functions. Further, processing circuitry 68 of the network node 16 may include CU 100, DU 102, and/or RU 104. CU 100 may be configured to perform centralized unit functions, DU 102 may be configured to perform distributed unit functions including distributed unit network functions, and RU 104 may be configured to perform radio unit functions such as in an O-RAN and/or 3GPP network. DU 102 may refer to a DU network function (DU NF), e.g., where DU 102 is a DU NF, performs a network function (DU NF) and/or comprises a DU NF.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

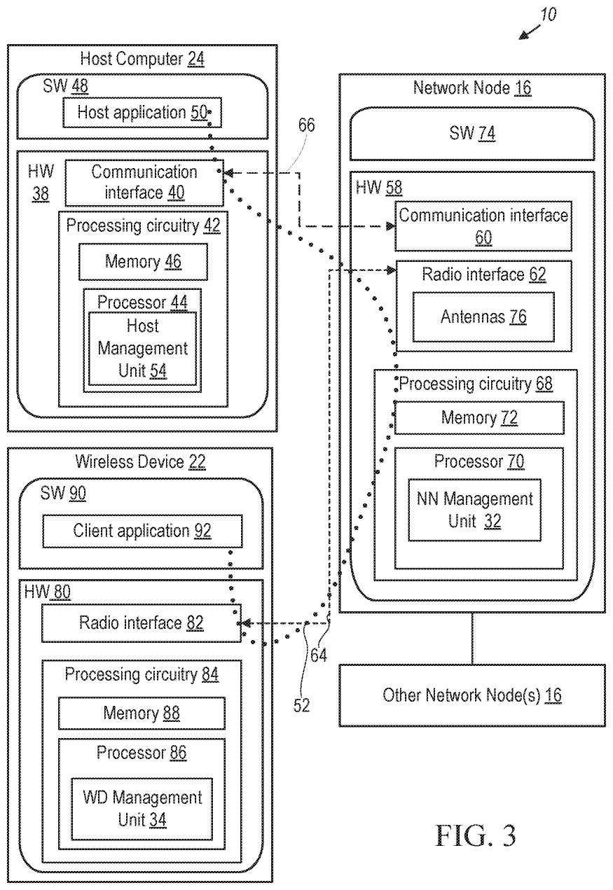

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or task and/or process and/or method and/or feature described in the present disclosure, e.g., WD functions. In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 4 is a flowchart illustrating an exemplary method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

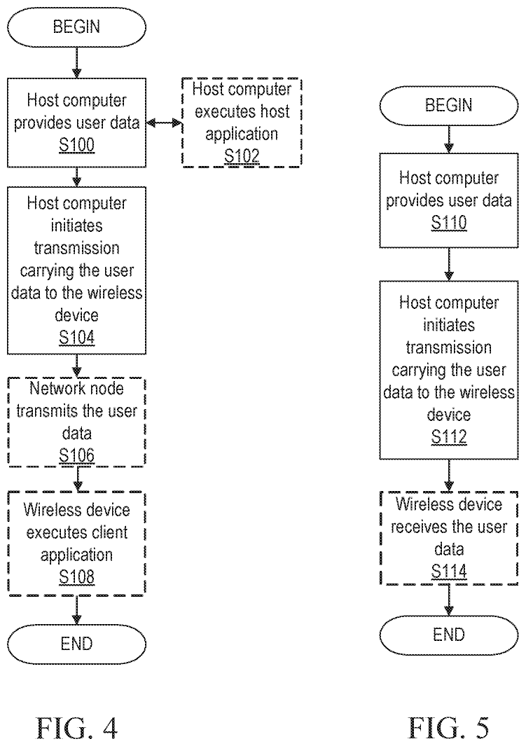

FIG. 5 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

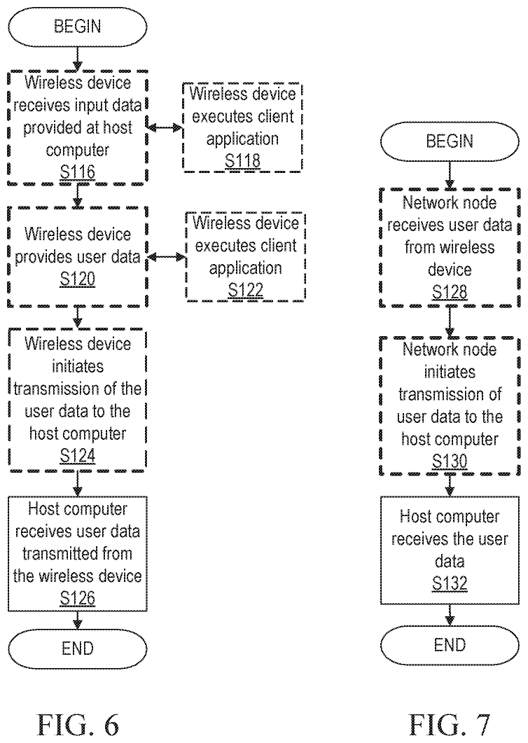

FIG. 6 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

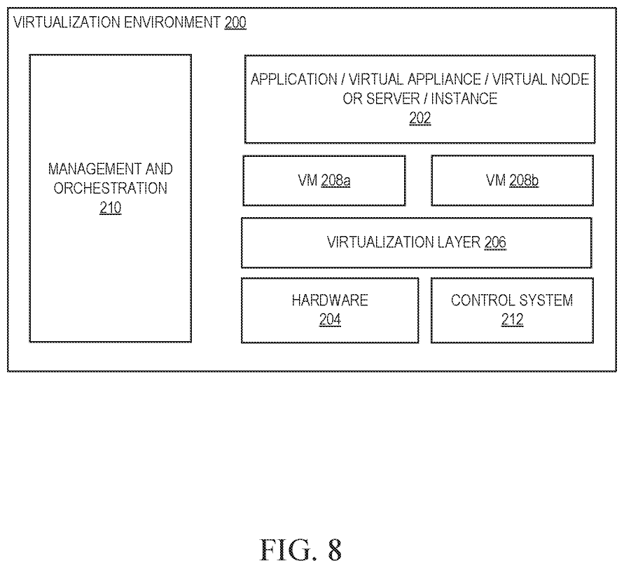

FIG. 8 is a block diagram illustrating a virtualization environment 200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 200 hosted by one or more of hardware nodes, such as a hardware computing device that operates as a network node, WD, core network node, or host. Further, in embodiments in which the virtual node does not require radio connectivity (e.g., a core network node or host), then the node may be entirely virtualized.

Applications 202 (which may alternatively be called software instances, virtual appliances, network functions, virtual nodes, virtual network functions, etc.) are run in the virtualization environment 200 to implement some of the features, functions, and/or benefits of some of the embodiments disclosed herein.

Hardware 204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 206 (also referred to as hypervisors or virtual machine monitors (VMMs)), provide VMs 208a and 208b (one or more of which may be generally referred to as VMs 208), and/or perform any of the functions, features and/or benefits described in relation with some embodiments described herein. The virtualization layer 206 may present a virtual operating platform that appears like networking hardware to the VMs.

The VMs 208 comprise virtual processing, virtual memory, virtual networking or interface and virtual storage, and may be run by a corresponding virtualization layer 206. Different embodiments of the instance of a virtual appliance 202 may be implemented on one or more of VMs 208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 208 may be a software implementation of a physical machine that runs programs as if they were executing on a physical, non-virtualized machine. Each of the VMs 208, and that part of hardware 204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 208 on top of the hardware 204 and corresponds to the application 202.

Hardware 204 may be implemented in a standalone network node with generic or specific components. Hardware 204 may implement some functions via virtualization. Alternatively, hardware 204 may be part of a larger cluster of hardware (e.g. such as in a data center or CPE) where many hardware nodes work together and are managed via management and orchestration 210, which, among others, oversees lifecycle management of applications 202. In some embodiments, hardware 204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 212 which may alternatively be used for communication between hardware nodes and radio units.

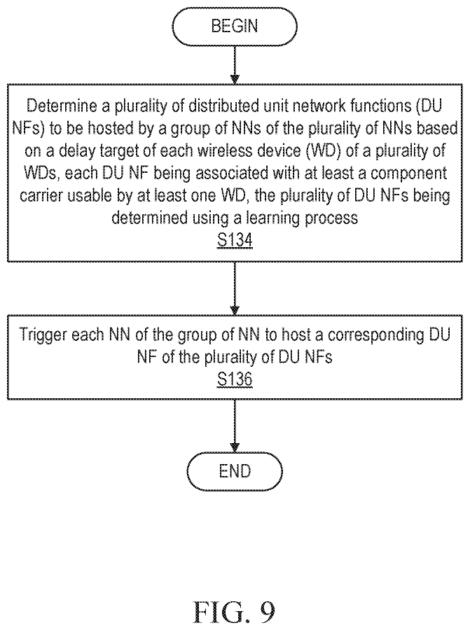

FIG. 9 is a flowchart of an exemplary process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S134) a plurality of distributed units network functions (DU NFs) (i.e., DUs 102) to be hosted by a group of NNs 16 of the plurality of NN 16 based on a delay target of each wireless device (WD) 22 of a plurality of WDs 22, where each DU NF is associated with at least a component carrier usable by at least one WD 22, the plurality of DU NFs is determined using a learning process, and trigger (Block S136) each NN 16 of the group of NN 16 to host a corresponding DU NF of the plurality of DU NFs.

In some embodiments, the method further comprises performing modeling of the network and performing modeling of end-to-end delay in the network based on data collected in the network to determine the plurality of DU NFs. In one or more embodiments, end-to-end delay refers to the time that elapses from the transmission of a packet or signaling from one component of system 10 to the reception (and/or processing) of the packet or signaling by another component. For example, end-to-end delay may be the time that elapses between the transmission of a signal by CU 100 (or DU 102) until the signal is received by a WD 22. Similarly, end-to-end delay may be the time that elapses between the transmission of a signal by WD 22 until the signal is received by a CU 100 (or DU 102). Further, end-to-end delay may refer to the time that elapses from the transmission of a packet or signaling from one segment of a network until reception by another segment of the network.

In some other embodiments, determining the plurality of DUs 102 comprises determining a WD centric DU NF placement based on carrier aggregation parameters and performing a weighted sum of a delay and a number of NNs 16 used to host DU NFs for a plurality of component carriers.

In some embodiments, determining the plurality of DU NFs using the learning process comprises one or more of modeling a state as a delay satisfaction of users, determining an action, where the action is a placement of at least one DU NF for the at least component carrier in the network, and determining a reward. The reward is the weighted sum of the delay and the number of NNs used to host DU NFs for the plurality of component carriers and the satisfaction of one or more constraints. The one or more constraints are based on computing capacity of the plurality of NNs, a bandwidth capacity of midhaul, inter-DU, and fronthaul links, and the delay target.

In some other embodiments, determining the plurality of DU NFs using the learning process comprises applying deep reinforcement learning-based DU placement with carrier aggregation (DUPCA) to minimize a quantity of DU NFs that are to be hosted by the group of NNs 16 while satisfying the delay target of each WD 22.

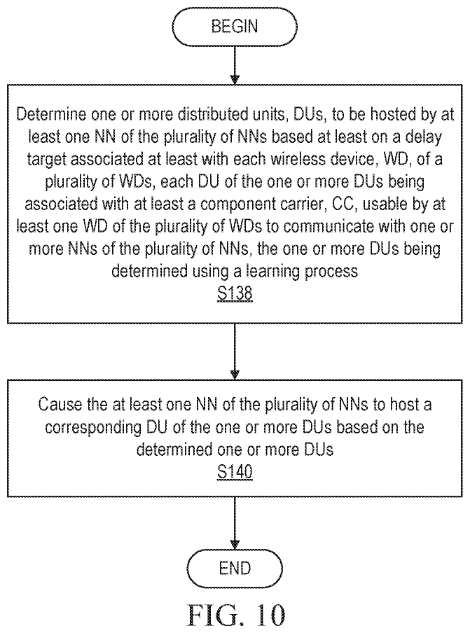

FIG. 10 is a flowchart of an exemplary process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to determine (Block S138) one or more distributed units (DUs) 102 to be hosted by at least one NN 16 of the plurality of NNs 16 based at least on a delay target associated at least with each wireless device (WD) 22 of a plurality of WDs 22. Each DU 102 of the one or more DUs 102 being associated with at least a component carrier (CC) 302 usable by at least one WD 22 of the plurality of WDs 22 to communicate with one or more NNs 16 of the plurality of NNs 16. The one or more DUs 102 are determined using a learning process. The network node 16 is further configured to cause (Block S140) the at least one NN 16 of the plurality of NNs 16 to host a corresponding DU 102 of the one or more DUs 102 based on the determined one or more DUs 102.

In some embodiments, the method further includes performing modeling of the network to determine the one or more DUs 102.

In some other embodiments, the method further includes performing modeling of an end-to-end delay in the network based on data collected in the network, where the one or more DUs 102 are determined based on the modeling of the end-to-end delay.

In some embodiments, determining the one or more DUs 102 comprises determining a DU placement on the at least one NN 16 based on carrier aggregation parameters.

In some other embodiments, determining the one or more DUs 102 comprises determining a weighted sum of a delay associated with data corresponding to the plurality of WDs 22 and a number of NNs 16 used to host the one or more DUs 102. The weighted sum is determined for the at least component carrier (CC) 302 of a plurality of CCs 302.

In some embodiments, determining the one or more DUs 102 using the learning process comprises one or more of (A) modeling a state as a delay satisfaction of one or more users associated with the plurality of WDs 22; (B) determining an action associated with the learning process, where the action is a placement of the one or more DUs 102 in the at least one NN 16 for the at least one NN 16 to host the one or more DUs 102, and the placement is for a corresponding CC 302; and (C) determining a reward associated with the learning process, the reward being the weighted sum of the delay and the number of NNs 16 used to host the one or more DUs 102 for the plurality of CCs 302.

In some other embodiments, the one or more DUs 102 are further determined based on one or more constraints, where the one or more constraints are based on computing capacity of the plurality of NNs 16, a bandwidth capacity of one or more mid-haul links, one or more inter-DU links, and one or more fronthaul links, and the delay target.

In some embodiments, determining the one or more DUs 102 using the learning process comprises applying deep reinforcement learning-based DU placement with carrier aggregation (DUPCA) to minimize a quantity of DUs 102 that are to be hosted by the at least one NN 16 while satisfying the delay target of each WD 22.

In some other embodiments, the method further includes one or more of (A) receiving a set of data corresponding to the plurality of WDs 22; (B) hosting at least one DU 102 of the one or more DUs 102 that corresponds to a first activated CC 302 of the at least one CC 302; (C) one or both of transmitting and receiving signaling associated with a first subset of the set of data to communicate with at least with a WD 22 via an access network node using the first activated CC 302; and (D) forwarding a second subset of data of the set of data to at least one other DU 102 of the one or more DUs 102. The at least one other DU 102 corresponds to a second activated CC 302 of the at least one CC 302. The second activated CC 302 and the first activated CC 302 are different.

In some embodiments, the one or more DUs 102 are one or more DU network functions.

Having described the general process flow of arrangements of the disclosure and having provided examples of hardware and software arrangements for implementing the processes and functions of the disclosure, the sections below provide details and examples of arrangements for network function placement with carrier aggregation in network(s) (e.g., cloud network(s)) which may include the use of machine learning processes for determining the network function placement. In one or more embodiments, the functions and/or tasks and/or steps described herein may be performed by one or more network nodes 16 and/or one or more WDs 22.

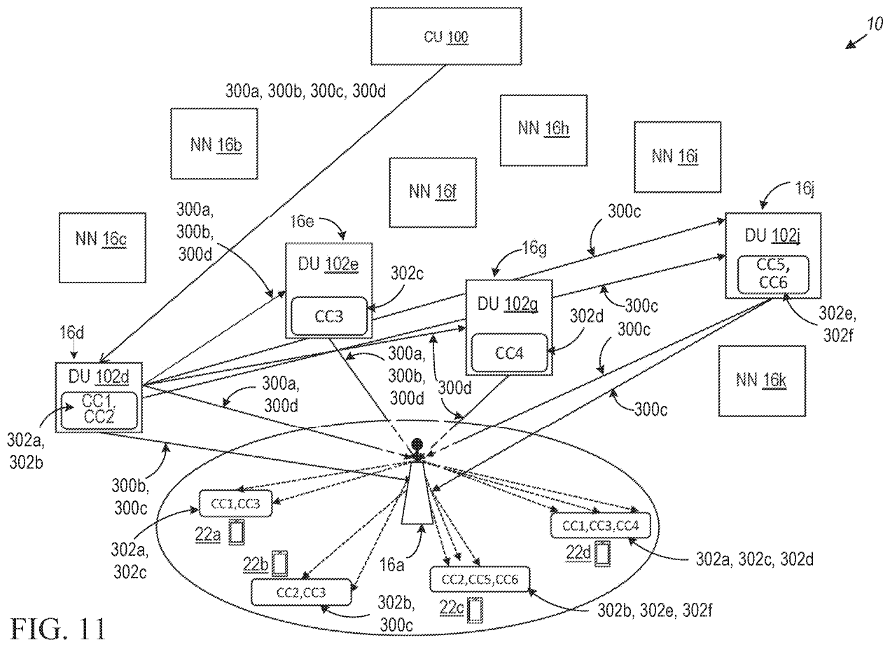

FIG. 11 shows a system 10 (e.g., 5G network configured for carrier aggregation (CA)) which includes NNs 16 (e.g., NNs 16a-16k), WDs 22 (e.g., WDs 22a, 22b, 22c, 22d), a CU 100 (which may be comprised in NN 16), multiple DUs 102 (e.g., DU NFs) and RU 104 (e.g., in NN 16a) serving multiple WDs 22. More specifically, NNs 16 may comprise an access NN 16a, such as a RAN network node, and other network nodes 16 such as O-Cloud nodes. Data 300 may be transmitted between components of system. 10 or to/from any other component not comprised in system 10. Further, multiple component carriers (CCs) 302 may be used for communication with WDs 22.

For example, using CA, each WD 22 may have a given set of supported CCs 302. Each WD 22 has one primary cell 18 (PCell) and several activated secondary cells 18 (SCells). The PCell may be active at all times for a given WD 22. Network functions (NFs) of each DU 102 related to each CC 302 may run in one NN 16 (e.g., O-Cloud node). In this nonlimiting example, the data 300a, 300b, 300c, 300d (collectively referred to as data 300) of each WD 22 is transmitted from the CU 100 to the serving DU 102 (e.g., DU NF) for the PCell of that WD 22. Data 300a, 300b, 300c, and 300d may be referred to as U1, U2, U3, U4, respectively. In some embodiments, data 300a may correspond to WD 22a, data 300b may correspond to WD 22b, data 300c may correspond to WD 22d, and data 300d may correspond to WD 22e. However, to which WD 22 data 300 corresponds is not limited as such, and any combination of data 300 may correspond to one or more WDs 22. In some embodiments, data 300 may also refer to data payload.

The PCell of each WD 22 may have the role of distributing the user data 300 among DUs 102 of all activated CCs 302 (e.g., one or more of CC 302a, 302b, 302c, 302d, 302e, 302f, etc.) for that specific WD 22. Hence, there is an inter DU (IDU) communication between the DU 102 (e.g., DU NF) serving the PCell and the DU 102 (e.g., DU NF) serving the SCell of the given user (i.e., WD 22) in the given time interval.

In this nonlimiting example, there are six CCs 302 and four WDs 22. CCs 302a, 302c (e.g., a first CC and a third CC) are activated for WD 22a. CCs 302b, 302c (e.g., a second CC and the third CC) are activated for WD 22b. CCs 302b, 302e, 302f (e.g., the second CC, a fifth CC, a sixth CC) are activated for WD 22c, and CCs 302a, 302c, 302d (e.g., the first CC, the third CC and a fourth CC) are activated for WD 22d. CC 302a may be assumed to be the PCell for WD 22a and WD22d, and CC 302b may be assumed to be the PCell for WD 22b and WD 22c. The data 300 of each WD 22 may be received in its PCell, and then it is split among all activated CCs 302.

In some embodiments, downlink traffic may be considered, and the end-to-end delay from the CU 100 to each WD 22 may be determined. Decisions about NNs 16 (e.g., the O-Cloud nodes) which are to be selected to instantiate the NEs of the DUs 102 (e.g., DU NFs) for the CCs 302 may be executed every time duration (TD). In some embodiments, during TD, the decisions may not be changed. The arrived burst of data payloads of WD u (e.g., UE u) in the current duration time is transmitted from CU 100 to a NN 16 (e.g., a cloud node) serving the DU 102 (e.g., DU NF) of the WD PCell and then is split among its activated CCs. For example, the burst of data may be data 300a, 300b, 300c, 300d. The delay from CU 100 to each WD 22 includes processing, transmission, propagation, queuing, etc. These delays are related to CU 100, DU nodes (NNs 16 hosting a DU 102, DU NFs, etc.) and RU 104, as well as MH, IDU and FH links. In some embodiments, to satisfy the delay target, the delay to transmit one data packet of each WD 22 must be lower than or equal to its target such as a predetermined delay threshold.

In some embodiments, noting the delay experienced by the WDs 22 (e.g., users), the delay may increase if the DU 102 (e.g., DU NF) of all CCs run in one NN 16. Moreover, if the DUs 102 (e.g., DU NFs) for the CCs 302 are distributed in different NNs 16, the IDU delay, and the number of processing nodes increases. In some other embodiments, the delay may be minimized while minimizing the number of placed DUs 102 and satisfying the delay target of each user or WD 22.

In the example shown, NN 16d receives data 300a, 300b, 300c, 300d for WDs 22a, 22b, 22c, 22d, respectively. Each WD 22 has CCs 302 activated as described above. NN 16d is selected to instantiate and/or comprise and/or perform the functions of DU 102d. NN 16e is selected to instantiate and/or comprise and/or perform the functions of DU 102e. NN 16g is selected to instantiate and/or comprise and/or perform the functions of DU 102g. NN 16j is selected to instantiate and/or comprise and/or perform the functions of DU 102j. Each selected DU 102 may be configured to communicate with a corresponding WD 22, e.g., via network node 16a and corresponding CCs 302. For example, DU 102d may be configured to communicate with WDs 22a, 22d, by transmitting signaling associated with data 300a, 300d to WDs 22a, 22d (e.g., via NN 16a) using CC 302a. Further, DU 102d may be configured to communicate with WDs 22b, 22c, by transmitting signaling associated with data 300b, 300c to WDs 22b, 22c (e.g., via NN 16a) using CC 302b.

DU 102e may be configured to communicate with WDs 22a, 22b, 22d, by transmitting signaling associated with data 300a, 300b, 300d to WDs 22a, 22b, 22d (e.g., via NN 16a) using CC 302c. DU 102g may be configured to communicate with WD 22d, by transmitting signaling associated with data 300d to WD 22d (e.g., via NN 16a) using CC 302d. DU 102j may be configured to communicate with WD 22c, by transmitting signaling associated with data 300c to WD 22c (e.g., via NN 16a) using CCs 302e, 302f.

Put differently, CC 302a associated with DU 102d may be used to transmit and/or receive data 300a to/from WDs 22a, 22d. CC 302b associated with DU 102d may be used to transmit and/or receive data 300b to/from WDs 22b, 22c. CC 302c associated with DU 102e may be used to transmit and/or receive data 300a, 300b, 300d to/from WDs 22a, 22b, 22d. CC 302d associated with DU 102g may be used to transmit and/or receive data 300d to/from WD 22d. CC 302e associated with DU 102j may be used to transmit and/or receive data 300c to/from WD 22c. In addition, CC 302j associated with DU 102j may be used to transmit and/or receive data 300c to/from WD 22c.

In one or more embodiments, data 300 that is associated with a CC 302 is forwarded to the corresponding DU 102. For example, data 300a, 300b, 300d associated with CC 302c may be forwarded by DU 102d to DU 102e for DU 102e to perform one or more actions (e.g., transmitting/receiving signaling) associated with CC 302c and data 300a, 300b, 300d. Data 300d associated with CCs 302d may be forwarded by DU 102d to DU 102g for DU 102g to perform one or more actions (e.g., transmitting/receiving signaling) associated with CC 302d and data 300d. Data 300c associated with CC 302c, 302f may be forwarded by DU 102d to DU 102j for DU 102j to perform one or more actions (e.g., transmitting/receiving signaling) associated with CC 302e, 302f and data 300c.

In some embodiments, DU 102 may refer to a DU NF. In some other embodiments, the selection of DUs 102 (and/or corresponding NN 16) may be performed by any component of system 10 such as a NN 16, may be based on optimization variables such as a delay target of one or more WDs 22, and may be performed using a learning process and/or artificial intelligence process. In one or more embodiments, the term “to host” may refer to performing one or more actions associated with the hosted entity. For example, a NN 16 may be configured to host a DU 102 (or DU NF) or an instance of DU 102. Thus, NN 16, by hosting DU 102, may be configured to perform or cause the hosted DU 102 to perform one or more DU functions. In addition, by hosting DU 102, NN 16 may execute software, e.g., via hardware components, to perform the DU functions. In some embodiments, causing a NN 16 to host a DU may comprise causing a DU to be instantiated or deployed to the NN 16.

In some embodiments, optimization variables may include the optimum placement of DU 102 (e.g., DU NFs) for each CC. Further, a weighted sum scheme may be used to solve this multi-objective problem (the delay and the number of placed DUs). The problem, which may be non-linear, may be solved by using a Deep Reinforcement Learning (DRL) algorithm or any other artificial intelligence process and/or machine learning process.

In some other embodiments, DLR algorithms may use one or more agents configured to receive one or more states (of the system) and/or perform one or more actions that produce one or more rewards such as based on the one or more states. In some embodiments, using the DRL approach, a DU NF placement for each CC may be determined. In each iteration, the DU placement for the CCs, the wireless channel and the user traffic causes an environment change, and the DRL agent gets a reward. An objective function may be used to determine the reward. In the DRL algorithm, the problem may be modeled as a Markov Decision Process (MDP). The MDP approach may involve one or more of the following:
A state is modelled as the delay satisfaction of the users associated with the WDs 22.
The action is the placement of the DU 102 (e.g., DU NFs) for the CCs in the network (e.g., cloud network).
The reward is the weighted sum of the delay and the number of consumed NNs 16 (e.g., cloud nodes) used for DUs 102 and the satisfaction of one or more constraints. The constraints may depend on computing capacity of the NNs 16 (e.g., cloud nodes), the bandwidth capacity of the links (MH, IDU, FH) and the WD delay target/threshold.

In some embodiments, by using an ML algorithm based on the DQN, an optimum solution for the stated delay problem may be determined. Specifically as part of the problem definition, the following formulation is defined:

$$O = {\sum }_{n ∈ N} f ( {\sum }_{m ∈ M} {x}_{m}^{n} )$$

where O(t) denotes the number of placed DUs 102 (e.g., DU NFs) at the current time, t, and

$$f ( x ) = \{ \begin{matrix}1 , & x > 0 \\ 0 , & x = 0\end{matrix}$$

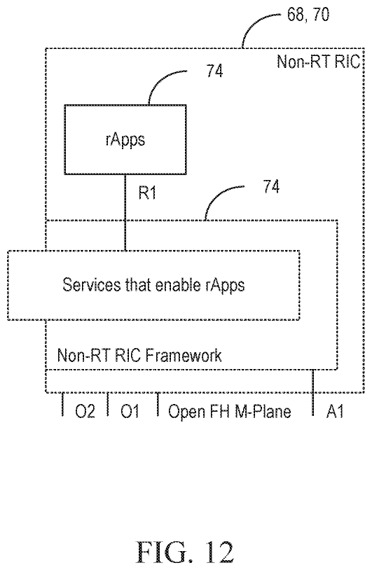

Constraints may ensure that the total computing resources in CU, RU and DU n are lower than a maximum resource. In addition, the constraints may ensure that the bandwidth requirements of the MH, IDU and FH links are supported. FIG. 12 shows an example service management and orchestration (SMO) framework. The SMO framework may comprise non-RT RIC (i.e., processing circuitry 68 and/or processor 70 of network node 16) and software 74 which may comprise one or more rApps, services that enable rApps, and/or a non-RT RIC framework. rApps may communicate with the services such as via interface R1 (which may be comprised in communication interface 60). Further, other interfaces may include O2, O1, Open FH M-plane A1, any of which may perform one or more functions corresponding to communication interface 60.

In some embodiments, the functions and/or tasks and/or processes and/or steps described in the present disclosure are performed by one or more rApps, e.g., comprised in network node 16.

One or more embodiments are applicable to cloud networks. In some embodiments, in order to gain the full optimization of DU NF placement, the DU NFs may be instantiated on any capable NN 16 (e.g., cloud node) and is not limited solely to NNs 16 that provide wireless communication to WDs 22 (and conversely is not excluded from to NNs 16 that provide wireless communication to WDs 22). As such, although FIG. 3 shows NN 16 in communication with WD 22, such illustration is for ease of explanation.

Implementations are not limited solely to what is shown in the figures of the present disclosure. Further, the embodiments of the present disclosure are not limited to a type of network such as cloud networks and may be applicable to any network, including those conforming to O-RAN O-Cloud specifications, cloud networks supported by 3GPP, or those provided by cloud providers such as Microsoft Azure, Google, Apple, Amazon Web Services, etc.

The following is a nonlimiting list of example embodiments.

Embodiment A1. A first network node (NN) 16 configured to communicate with a with a plurality of NNs 16 in a network, the first network node 16 configured to, and/or comprising a communication interface 60 and/or comprising processing circuitry 68 configured to:
determine a plurality of distributed unit (DU NFs) to be hosted by a group of NNs 16 of the plurality of NNs 16 based on a delay target of each wireless device (WD) 22 of a plurality of WDs 22, each DU NF being associated with at least a component carrier usable by at least one WD 22, the plurality of DU NFs being determined using a learning process; and
trigger each NN 16 of the group of NNs 16 to host a corresponding DU NF of the plurality of DU NF8.

Embodiment A2. The first network node of Embodiment A1, wherein the first NN 16 is further configured to:
perform modeling of the network; and
perform modeling of end-to-end delay in the network based on data collected in the network to determine the plurality of DU NFs.

Embodiment A3. The first network node of any one of Embodiments A1 and A2, wherein determining the plurality of DUs comprises:
determining a WD centric DU NF placement based on carrier aggregation parameters; and
performing a weighted sum of a delay and a number of NNs 16 used to host DU NFs for a plurality of component carriers.

Embodiment A4. The first network node of any one of Embodiments A1-A3, wherein determining the plurality of DU NFs using the learning process comprises one or more of:
modeling a state as a delay satisfaction of users;
determining an action, the action being a placement of at least one DU NF for the at least component carrier in the network; and
determining a reward, the reward being the weighted sum of the delay and the number of NNs 16 used to host DU NFs for the plurality of component carriers and the satisfaction of one or more constraints, the one or more constraints being based on computing capacity of the plurality of NNs 16, a bandwidth capacity of midhaul, inter-DU, and fronthaul links, and the delay target.

Embodiment A5. The first network node of any one of Embodiments A1-A4, wherein determining the plurality of DU NEs using the learning process comprises:
applying deep reinforcement learning-based DU placement with carrier aggregation (DUPCA) to minimize a quantity of DUs that are to be hosted by the group of NNs 16 while satisfying the delay target of each WD 22.

Embodiment B1. A method implemented in a first network node (NN) 16 configured to communicate with a plurality of NNs 16 in a network, the method comprising:
determining a plurality of distributed unit network functions (DU NFs) to be hosted by a group of NNs 16 of the plurality of NN based on a delay target of each wireless device (WD) 22 of a plurality of WDs 22, each DU NF being associated with at least a component carrier usable by at least one WD 22, the plurality of DU NFs being determined using a learning process; and
triggering each NN 16 of the group of NNs 16 to host a corresponding DU NF of the plurality of DU NFs.

Embodiment B2. The method of Embodiment B1, wherein the method further comprises:
performing modeling of the network; and
performing modeling of end-to-end delay in the network based on data collected in the network to determine the plurality of DU NFs.

Embodiment B3. The method of any one of Embodiments B1 and B2, wherein determining the plurality of DUs comprises:
determining a WD centric DU NF placement based on carrier aggregation parameters; and
performing a weighted sum of a delay and a number of NNs 16 used to host DU NFs for a plurality of component carriers.

Embodiment B4. The method of any one of Embodiments B1-B3, wherein determining the plurality of DU NFs using the learning process comprises one or more of:
modeling a state as a delay satisfaction of users;
determining an action, the action being a placement of at least one DU NF for the at least component carrier in the network; and
determining a reward, the reward being the weighted sum of the delay and the number of NNs 16 used to host DU NFs for the plurality of component carriers and the satisfaction of one or more constraints, the one or more constraints being based on computing capacity of the plurality of NNs 16, a bandwidth capacity of midhaul, inter-DU, and fronthaul links, and the delay target.

Embodiment B5. The method of any one of Embodiments B1-B4, wherein determining the plurality of DU NFs using the learning process comprises: applying deep reinforcement learning-based DU placement with carrier aggregation (DUPCA) to minimize a quantity of DUs that are to be hosted by the group of NNs 16 while satisfying the delay target of each WD 22.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
CA Carrier Aggregation
CC Component Carrier
CNF Containerized Network Function
CU Central Unit
DON Deep Q-Network
DRL Deep Reinforcement Learning
DU Distributed Unit
DUPCA DU Placement with Carrier Aggregation
FH Front Haul
IDU Inter-DU
MDP Markov Decision Process
MH Mid Haul
MILP Mixed Integer Linear Problem
ML Machine Learning
NF Network Function
PCell Primary Cell
RAN Radio Access Network
RU Radio Unit
SCell Secondary Cell
UE User Equipment
VNF Virtualized Network Function

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a first network node, NN, configured to communicate with a plurality of NNs in a network, the method comprising:
determining one or more distributed units, DUs, to be hosted by at least one NN of the plurality of NNs based at least on a delay target associated at least with each wireless device, WD, of a plurality of WDs, each DU of the one or more DUs being associated with at least a component carrier, CC, usable by at least one WD of the plurality of WDs to communicate with one or more NNs of the plurality of NNs, the one or more DUs being determined using a learning process; and
causing the at least one NN of the plurality of NNs to host a corresponding DU of the one or more DUs based on the determined one or more DUs.

2. The method of claim 1, wherein the method further includes:
performing modeling of the network to determine the one or more DUs.

3. The method of claim 1, wherein the method further includes:
performing modeling of an end-to-end delay in the network based on data collected in the network, the one or more DUs being determined based on the modeling of the end-to-end delay.

4. The method of claim 1, wherein determining the one or more DUs comprises:
determining a DU placement on the at least one NN based on carrier aggregation parameters.

5. The method of claim 1, wherein determining the one or more DUs comprises:
determining a weighted sum of a delay associated with data corresponding to the plurality of WDs and a number of NNs used to host the one or more DUs, the weighted sum being determined for the at least component carrier, CC, of a plurality of CCs.

6. The method of claim 5, wherein determining the one or more DUs using the learning process comprises one or more of:
modeling a state as a delay satisfaction of one or more users associated with the plurality of WDs;
determining an action associated with the learning process, the action being a placement of the one or more DUs in the at least one NN for the at least one NN to host the one or more DUs, the placement being for a corresponding CC; and
determining a reward associated with the learning process, the reward being the weighted sum of the delay and the number of NNs used to host the one or more DUs for the plurality of CCs.

7. The method of claim 1, wherein the one or more DUs are further determined based on one or more constraints, the one or more constraints being based on computing capacity of the plurality of NNs, a bandwidth capacity of one or more mid-haul links, one or more inter-DU links, and one or more fronthaul links, and the delay target.

8. The method of claim 1, wherein determining the one or more DUs using the learning process comprises:
applying deep reinforcement learning-based DU placement with carrier aggregation, DUPCA, to minimize a quantity of DUs that are to be hosted by the at least one NN while satisfying the delay target of each WD.

9. The method of claim 1, wherein the method further includes one or more of:
receiving a set of data corresponding to the plurality of WDs;
hosting at least one DU of the one or more DUs that corresponds to a first activated CC of the at least one CC;
one or both of transmitting and receiving signaling associated with a first subset of the set of data to communicate with at least with a WD via an access network node using the first activated CC; and
forwarding a second subset of data of the set of data to at least one other DU of the one or more DUs, the at least one other DU corresponding to a second activated CC of the at least one CC, the second activated CC and the first activated CC being different.

10. The method of claim 1, wherein the one or more DUs are one or more DU network functions.

11. A first network node, NN, configured to communicate with a plurality of NNs in a network, the first network node being configured to:
determine one or more distributed units, DUs, to be hosted by at least one NN of the plurality of NNs based at least on a delay target associated at least with each wireless device, WD, of a plurality of WDs, each DU of the one or more DUs being associated with at least a component carrier, CC, usable by at least one WD of the plurality of WDs to communicate with one or more NNs of the plurality of NNs, the one or more DUs being determined using a learning process; and
cause the at least one NN of the plurality of NNs to host a corresponding DU of the one or more DUs based on the determined one or more DUs.

12. The first network node of claim 11, wherein the first NN is further configured to:
perform modeling of the network to determine the one or more DUs.

13. The first network node of claim 11, wherein the first NN is further configured to:
perform modeling of an end-to-end delay in the network based on data collected in the network, the one or more DUs being determined based on the modeling of the end-to-end delay.

14. The first network node of claim 11, wherein determining the one or more DUs comprises:
determining a DU placement on the at least one NN based on carrier aggregation parameters.

15. The first network node of claim 11, wherein determining the one or more DUs comprises:
determining a weighted sum of a delay associated with data corresponding to the plurality of WDs and a number of NNs used to host the one or more DUs, the weighted sum being determined for the at least component carrier, CC, of a plurality of CCs.

16. The first network node of claim 15, wherein determining the one or more DUs using the learning process comprises one or more of:
modeling a state as a delay satisfaction of one or more users associated with the plurality of WDs;
determining an action associated with the learning process, the action being a placement of the one or more DUs in the at least one NN for the at least one NN to host the one or more DUs, the placement being for a corresponding CC; and
determining a reward associated with the learning process, the reward being the weighted sum of the delay and the number of NNs used to host the one or more DUs for the plurality of CCs.

17. The first network node of claim 11, wherein the one or more DUs are further determined based on one or more constraints, the one or more constraints being based on computing capacity of the plurality of NNs, a bandwidth capacity of one or more mid-haul links, one or more inter-DU links, and one or more fronthaul links, and the delay target.

18. The first network node of claim 11, wherein determining the one or more DUs using the learning process comprises:
applying deep reinforcement learning-based DU placement with carrier aggregation, DUPCA, to minimize a quantity of DUs that are to be hosted by the at least one NN while satisfying the delay target of each WD.

19. The first network node of claim 11, wherein the first network node is configured to one or more of:
receive a set of data corresponding to the plurality of WDs;
host at least one DU of the one or more DUs that corresponds to a first activated CC of the at least one CC;
one or both of transmit and receive signaling associated with a first subset of the set of data to communicate with at least with a WD via an access network node using the first activated CC; and
forward a second subset of data of the set of data to at least one other DU of the one or more DUs, the at least one other DU corresponding to a second activated CC of the at least one CC, the second activated CC and the first activated CC being different.

20. The first network node of claim 11, wherein the one or more DUs are one or more DU network functions.
